(19) United States
(12) Patent Application Publication
(10) Pub. No.: US 2008/0038206 A1
(43) Pub. Date: Feb. 14, 2008

(54) Product release system for atomizing compositions containing hair-keratin-reducing or oxidative active ingredients

(76) Inventors: Karin Steinbrecht, Ober-Ramstadt (DE); Thorsten Cassier, Dieburg (DE); Wilfried Burg, Gross-Gerau (DE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/471,455

(22) Filed: Jun. 20, 2006

(51) Int. Cl. A61J 1/00; A61Q 5/04

(52) U.S. Cl. 424/41

(57) ABSTRACT

A product release system for atomizing compositions is described, which has (a) a pressure-resistant packaging, (b) a capillary-containing spray head, and (c) a propellant-containing composition. The atomization occurs using the capillary and the composition contains at least one reactive agent, which is selected from hair-keratin-reducing compounds or is selected from oxidizing agents. The capillary preferably has a diameter of 0.1 to 1 mm and a length of 5 to 100 mm. The spray rate is preferably 0.01 to 5 g/s. The propellant-free composition can, in particular, be gel-like, waxy, non-fluid, or solid and can be used in a method for permanent hair shaping.

The present invention relates to a product for implementing keratin-reducing or oxidative treatments in various application fields such as, for example, cosmetics, dental technology, pharmaceuticals, textile treatment, and cleaning agents. The product according to the present invention is particularly well suited for use with cosmetic hair treatments such as, for example, permanent hair shaping, bleaching, or oxidative hair coloring. The object of the present invention is a product release system for atomizing compositions having pressure-resistant packaging, a capillary-containing spray head, and a propellant-containing composition, wherein the composition contains at least one reactive ingredient, which is selected from hair-keratin-reducing compounds or from oxidizing agents. The object of the invention is also the use of the product release system for hair treatment, particularly for permanent hair shaping as well as a corresponding method for permanent hair shaping.

The need for such an agent should be shown in the following using the example of the hair/cosmetic application field. Hair treatment agents containing oxidizing agents are used for various applications in the cosmetics/hair industry, wherein hydrogen peroxide is the most commonly contained oxidizing agent therein. These oxidative hair treatment agents play an important role in a series of cosmetic hair treatments, e.g., in bleaching, oxidative hair coloring, and as a fixing agent in permanent hair shaping. To minimize the risk of skin irritations, it is desirable if the oxidative formulation, to the extent possible, can be precisely applied to the hair, does not run off, and does not reach the scalp or only does so to a slight extent. The undesirable run-off can be minimized by using strongly thickened, highly viscous compositions, e.g., gels or emulsion-type creams. The disadvantage of these highly viscous, strongly thickened products is that they can be difficult to localize at the desired site without coming into contact with the hands, they don't dispense well, and they provide poor and uneven distributability on the hair. A brush is often used to ensure a targeted and even treatment, which is very awkward.

In permanent hair shaping, hair is normally first treated with a shaping agent based on a keratin-reducing compound, which causes an opening of the disulfide bridges of the hair keratin, after which the hair is set in the desired shape. Keratin-reducing mercapto compounds, such as salts or esters of mercaptocarboxylic acids, are normally used as the shaping ingredient. Subsequently, the hair is rinsed with water and then oxidatively treated with a fixing agent containing an oxidizing agent. In this process, the previously split disulfide bridges are re-linked in the new shape. To minimize the risk of skin irritations, it is desirable for the reductive shaping agent as well if it can be precisely applied to the hair, does not run off, and does not reach the scalp or only does so to a slight extent. A targeted application only to certain parts of the hair is also desirable if the permanent shaping of the hair roots is only to be refreshed or if structural differences between the hair roots and hair tips should be considered during the permanent shaping, so that various sections of hair should precisely come into contact with various compositions having differing concentrations of keratin-reducing ingredient. Product run-off or product escaping into unintended sections of hair is also undesirable for these targeted applications. While thickened, highly viscous compositions, for example in the form of creams or gels, do reduce the risk of run-off, they have the disadvantage that they are difficult to distribute and/or can only be applied awkwardly using a brush. Previously, it was not possible to dispense higher viscosity, thickened, or non-fluid reductive or oxidative formulations from the packaging and to apply them with as much precision and even distribution, in a simple manner, as can be obtained with low-viscosity products.

A process for atomizing liquids is known from WO 03/051523 A1 with which the spray is formed using a capillary. Only the application with respect to atomizing liquid compositions is described. A fixture for atomizing liquid products is described in WO 03/051522 A2, wherein the spray is formed using a capillary. Only the use of liquid compositions are described for atomizing, which can also be highly viscous, wherein 5,000 mPa s is mentioned as the maximum sprayable viscosity.

Thus there was a need for keratin-reducing or oxidative products with improved dispensability, better distributability, and more comfortable applicability with a reduced risk of run-off into undesirable areas during application. The reductive and/or oxidative effects should correspond to those of conventional highly viscous or non-fluid products or even go beyond the effects of previously known products.

The object of the invention is a product release system for atomizing compositions. The product release system has the following features:

(a) pressure-resistant packaging,

(b) a spray head containing a capillary, and

(c) a composition containing a propellant, wherein the atomization occurs using the capillary and the composition contains at least one reactive agent, which is selected from hair-keratin-reducing compounds or is selected from oxidizing agents. The composition is preferably a cosmetic composition suitable for hair treatment.

The term “atomize” is understood to mean the release of the product in the form of dissipated particles. The dissipated particles can have varying shapes, consistency, and sizes. The properties of the atomized particles can include everything from fine aerosol atomized spray to liquid drops, snow-like drops, solid spray flakes and spray foam.

The quantities of ingredients (e.g., wt %) indicated in the following are each based on the basic composition without propellant unless explicitly indicated otherwise. The quantities of the propellant are based on the total composition including propellant.

The properties of the compositions to be used according to the invention that are related to consistency are based on the base composition without propellant (unless explicitly indicated otherwise). Non-liquid or non-fluid compositions in terms of the invention are particularly non-flow-capable compositions, which, for example, can be determined due to the fact that they will not flow off of a glass surface tilted at 45° at a temperature of 25° C. Non-liquid compositions can be, for example, solid, pasty, or creamy. Gel compositions are characterized in that the memory module G′ is larger than the loss module G″ at 25° C. with oscillographic measurements in the typical measurement range (0.01 to 40 Hz).

The composition is preferably non-liquid at 25° C. and/or has a viscosity of greater than 200, or particularly greater than 500 or greater than 1,000 mPa s and up to 100,000, with up to 50,000 or up to 35,000 mPa s being particularly preferred, measured with a HAAKE VT-550 Rheometer, SV-DIN test body at a temperature of 25° C. and a shear speed of 12.9 s-l. Non-liquid compositions are, for example, non-fluid, gel-type, waxy, emulsion-type, creamy, pasty, or solid, wherein a viscosity measurement is sometimes no longer possible.

Aerosol spray cans constructed of metal or plastic can be used as the pressure-resistant packaging. Preferred metals are tin plates and aluminum, while the preferred plastic is polyethylene terephthalate.

Suitable spray systems with capillary-containing spray heads, with which the spray is formed using a capillary, are described in WO 03/051523 A1 and in WO 03/051522 A2. The capillaries preferably have a diameter of 0.1 to 1 mm, or particularly of 0.2 to 0.6 mm and a length that is preferably 5 to 100 mm, or particularly 5 to 50 mm. The spray principle is also described in Aerosol Europe, vol. 13, no. 1-2005, pages 6-11. The spray system is based on the principle of capillary atomization. The conventional swirl nozzle as well as, if necessary, the uptake tube are replaced by capillaries. The energy-consuming and propellant-intensive swirling of the content of the can and the required strong dilution of the product with solvents is not necessary as compared to conventional spray systems. Even if only a small quantity of propellant is used, the product rises upward on the wall of the uptake tube capillary and is propelled, after the valve in the (wider) capillary of the spray head, in the direction of the exit opening. In this manner, small drops from the flowing propellant are wrenched from the surface of the liquid and continue to flow as aerosol. Since there is no swirl chamber to inhibit the flow of the product nor any atomizing nozzle available, the energy in the system can be used much more efficiently to create the desired spray. The spray rate can be adjusted via the selection of the capillary geometry in conjunction with the interior pressure created by the propellant or a propellant mixture. Preferred spray rates are 0.01 to 0.5 g/s, or particularly 0.1 to 0.3 g/s. The size of the spray drops created with the atomization can be adjusted via the selection of the capillary geometry in conjunction with the interior pressure or the viscosity of the composition. Suitable capillary atomization systems can be obtained in a product called TRUSPRAY® from Boehringer Ingelheim microParts GmbH.

The preferred drop size distributions are those with which the dv(50) value is a maximum of 200 μm, e.g., of from 50 to 200 μm with a maximum of 100 μm being especially preferred, e.g., of from 70 to 90 μm and/or with which the dv(90) value is a maximum of 160 μm, e.g., of from 90 to 160 μm, with a maximum of 150 μm being especially preferred, e.g., of from 115 to 150 μm. The dv(50) or dv(90) values provide the maximum diameter, which 50% or 90% of a droplets have. The drop size distribution can, for example, be determined with the help of a particle measurement unit based on laser beam diffraction, e.g., a Malvern particle sizer measuring device. Compositions that form a snow-like consistency, flakes, or foam (spray foam) upon exiting the capillary spray system are also preferred.

The propellant to be used can be selected from lower alkanes, particularly C3 to C5 hydrocarbons such as, for example, n-butane, i-butane, and propane, or also mixtures thereof, as well as dimethylethers or fluorine hydrocarbons such as F 152a (1,I-difluoroethane) or F 134 (tetrafluoroethane) as well as other gaseous propellants present with the pressures considered, such as, for example, N₂, N₂O, and CO₂ as well as mixtures of the aforementioned propellants. The propellant is preferably selected from propane, n-butane, isobutane, dimethylether, fluorinated hydrocarbons, and mixtures thereof. The content of propellant is, in addition, preferably 15 to 85 wt %, with 25 to 75 wt % being especially preferred.

The product release system according to the invention can be used for hair treatment. The compositions containing an oxidizing agent can be, for example, permanent wave fixing agents, bleaching agents, or oxidative hair colorants. The compositions containing a keratin-reducing compound can be, for example, permanent wave agents or hair smoothing agents.

One embodiment relates to an agent for permanently shaping hair. Permanent shaping includes adding waves as well as smoothing the hair. The composition then contains at least one keratin-reducing compound. The keratin-reducing ingredient is preferably contained in a quantity of from 0.5 to 25 wt %, 1 to 20 wt %, or 5 to 15 wt %, in relation to the propellant-free composition. Keratin-reducing ingredients are, for example, sulfites or mercapto compounds, particularly mercapto carboxylic acids such as, for example, mercaptoacetic acid or thiolactic acid, or salts of mercapto carboxylic acids such as, for example, ammonium and guanidine salts of mercaptoacetic acid or thiolactic acid; as well as glycerol esters of mercaptoacetic acid, thioglycol acid amides, thioglycerol, 3-mercaptopropionic acid, cysteine, cysteine derivatives such as, for example, cysteine-2-hydroxyethyl ester, N-acetyl-L-cysteine, cysteamine, homocysteine, alkyl or acyl cysteines, mercapto acetamides, 2-mercaptopropionic acid amides or the salts or derivatives of these compounds, in particular, ammonium thioglycolate. Mercaptoacetic acid, cysteine, thiolactic acid and salts thereof are particularly preferred. A mixture of the aforementioned keratin-reducing compounds can also be contained.

It is advantageous if the permanent shaping agent also contains the disulfide of a hair keratin-reducing thiol, particularly dithioglycolate. The preferred usage quantity for the disulfide is from 1 to 20 percent by weight, but preferably from 2 to 10 percent by weight, wherein a ratio between the hair keratin-reducing compound and the disulfide of from 2 : 1 to 1 : 2, but particularly from 2: 1 to 1: 1, is preferred.

The pH value of the shaping agent is preferably 7 to 10, wherein the pH is preferably set with ammonia, organic amines such as, for example, monoethanolamine, ammonium and alkali carbonates or bicarbonates. A neutral or acidic (pH 4.5 to 7, preferably 6.5 to 6.9) hair shaping agent having an effective content of sulfites or mercaptocarboxylic acid esters or mercaptocarboxylic acid amides in an aqueous medium can also be considered. Esters of mercapto carboxylic acids are, for example, the glycolic esters or the glycerol esters of monothioglycolic acid. Mercapto acetamides or 2-mercaptopropionic acid amides, in a concentration of from 2 to 14 wt %; or the salts of sulfuiric acid, e.g., sodium, ammonium, or monoethanol ammonium sulfite, in a concentration of from 3 to 8 wt % (calculated as SO₂), are preferably used.

One embodiment relates to an agent for oxidative treatment of hair, e.g., the oxidative after-treatment (fixing) after use of a permanent hair shaping agent. The composition then contains at least one oxidizing agent. The oxidizing agent is preferably contained in a quantity of from 0.1 to 25 wt %, of from 0.5 to 20 wt %, of from 2 to 14 wt %, or of from 4 to 12 wt %, in relation to the propellant-free composition. The pH value of the formulation, particularly with the use of peroxide, is from 2 to 6, or preferably from pH 3 to 5. The pH value with the use of bromates is preferably from 6 to 9, or especially preferably from 7 to 8.5. Oxidizing agents are, for example, hydrogen peroxide, urea peroxide, bromates, persulfates, perborates, percarbonates, peroxides, iodines, particularly alkali bromates such as, for example, sodium and potassium bromate, ammonium bromate, alkaline earth bromates, alkali persulfates, alkaline earth persulfates, ammonium persulfate, alkali perborates such as, for example, sodium perborate, alkaline earth perborates, ammonium perborate, alkali percarbonates, alkaline earth percarbonates, ammonium percarbonate, calcium peroxide, and sodium iodate. Hydrogen peroxide is preferably used.

The oxidative composition according to the invention preferably contains one or more peroxide stabilizers, preferably in a quantity of from 0.01 to 2 wt % or of from 0.05 to 0.3 wt %. Peroxide stabilizers are, for example, dialkali hydrogen phosphates such as, for example, disodium hydrogen phosphate, p-acetamidophenol, oxyquinoline salts, 8-hydroxyquinoline sulfate, salicylic acid and salts thereof, 1-hydroxyethane-1,1-diphosphonic acid, tetrasodium-1-hydroxyethane-1,1-diphosphonate (CAS 3794-83-0; CTFA: TETRASODIUM ETIDRONATE), tetrasodium iminodisuccinate (CAS 144538-83-0), ethylenediamine tetrasodium acetate (INCI: EDTA), and N-(4-ethoxyphenyl)acetamide (CTFA: PHENACETIN).

In one embodiment, the composition to be used (without propellant) is gel-like and contains at least one thickener or gel-former preferably in a quantity of from 0.01 to 20 wt % or of from 0.1 to 10 wt %, of from 0.5 to 8 wt % or especially preferably of from 1 to 5 wt %. Materials for which the function “Viscosity Increasing Agent” is indicated in the International Cosmetic Ingredient Dictionary and Handbook, 10th edition, 2004 are essentially suitable. The thickener or gel-former is preferably a thickening polymer and is especially preferably selected from copolymers consisting of at least one first type of monomer, which is selected from acrylic acid and methacrylic acid, and at least one second type of monomer, which is selected from esters of acrylic acid and ethoxylated fatty alcohol; crosslinked polyacrylic acid; crosslinked copolymers consisting of at least one first type of monomer, which is selected from acrylic acid and methacrylic acid, and at least one second type of monomer, which is selected from esters of acrylic acid with C10 to C30 alcohols; copolymers consisting of at least one first type of monomer, which is selected from acrylic acid and methacrylic acid, and at least one second type of monomer, which is selected from esters of itaconic acid and ethoxylated fatty alcohol; copolymers consisting of at least one type of monomer, which is selected from acrylic acid and methacrylic acid, at least one second type of monomer, which is selected from esters of itaconic acid and ethoxylated C10 to C30 alcohol, and a third type of monomer, which is selected from C1 to C4 aminoalkyl acrylates; copolymers consisting of two or more monomers, which are selected from acrylic acid, methacrylic acid, acrylic acid esters and methacrylic acid esters; copolymers consisting of vinyl pyrrolidone and ammonium acryloyl dimethyltaurate; copolymers consisting of ammonium acryloyl dimethyltaurate and monomers selected from esters of methacrylic acid and ethoxylated fatty alcohols; hydroxyethyl cellulose; hydroxypropyl cellulose; hydroxypropyl guar; glyceryl polyacrylate; glyceryl polymethacrylate; copolymers consisting of at least one C2, C3, or C4 alkylene and styrene; polyurethane; hydroxypropyl starch phosphate; polyacrylamide; copolymers crosslinked with decadiene consisting of maleic acid anhydride and methyl vinyl ether; locust bean gum; guar gum; xanthan; dehydroxanthan; carrageenan; karaya gum; hydrolyzed corn starch; copolymers consisting of polyethylene oxide, fatty alcohols, and saturated methylene diphenyl diisocyanate (e.g., PEG-150/stearyl alcohol/SMDI copolymer).

In an additional embodiment, the composition is waxy and contains at least one wax that is solid at 25° C. in a quantity of from preferably 10 to 80 wt %, particularly of from 20 to 60 wt %, or of from 25 to 50 wt %, as well as, if necessary, other water-insoluble materials that are liquid at room temperature. The waxy consistency is preferably characterized in that the needle penetration number (unit of measurement 0.1 mm, test weight 100 g, testing time 5 s, test temperature 25° C.; according to DIN 51 579) is preferably in a range of from 2 to 70, or particularly of from 3 to 40 and/or that the composition can be melted and has a solidification point greater than 25° C., preferably in a range of from 30 to 70° C., and especially preferably in a range of from 40 to 55° C.

Principally any wax that is known in the prior art can be used as a wax or waxy material. These waxes include animal, vegetable, mineral, and synthetic waxes, microcrystalline waxes, macrocrystalline waxes, solid paraffins, petroleum jelly, Vaseline, ozocerite, montan wax, Fischer-Tropsch wax, polyolefin waxes, e.g., polybutene, beeswax, wool wax, and its derivatives such as, for example, wool wax alcohols, candelilla wax, olive wax, carnauba wax, Japan wax, apple wax, hydrogenated fats, fatty acid esters, fatty acid glycerides with a solidification point greater than 40° C., silicone waxes or hydrophilic waxes such as, for example, high-molecular-weight polyethylene glycol waxes with a molecular weight of from 800 to 20,000, preferably of from 2,000 to 10,000 g/mol. The waxes or waxy materials have a solidification point greater than 25° C., or preferably greater than 40° C. or 55° C. The needle penetration number 0.1 mm, 100 g, 5 s, 25° C.; according to DIN 51 579) preferably lies in the range of from 2 to 70, or especially 3 to 40.

In another embodiment, the composition is emulsion-like, wherein the consistency is preferably creamy. The emulsion can be a water-in-oil emulsion, an oil-in-water emulsion, a microemulsion, or a higher emulsion. In addition to water, preferably at least one fatty alcohol or one hydrophobic oil that is liquid at room temperature 25° C. as well as at least one emulsifier is contained. The content of fatty alcohol and/or oil is preferably 1 to 20 wt %, or particularly 2 to 10 wt %. The emulsifier content is preferably 0.01 to 30 wt %, or particularly 0.1 to 20 wt % or 0.5 to 10 wt %.

Saturated, mono-or poly-unsaturated, branched or unbranched fatty alcohols containing C₆-C₃₀, or preferably C₁₀-C₂₂, and especially preferably C₁₂-C₂₂ carbon atoms can be used as fatty alcohols. For example, decanol, octanol, octenol, dodecanol, dodecenol, decenol, octadienol, dodecadienol, decadienol, oleyl alcohol, eruca alcohol, ricinol alcohol, stearyl alcohol, isostearyl alcohol, cetyl alcohol, lauryl alcohol, myristyl alcohol, arachidyl alcohol, capryl alcohol, caprine alcohol, linoleyl alcohol, linolenyl alcohol, and behenyl alcohol, as well as Guerbet alcohols thereof can be used in terms of the invention, wherein this list should be considered exemplary and not limiting. The fatty alcohols are preferably derived, however, from natural fatty acids, wherein one can assume a recovery from the esters of fatty acids via reduction. Fatty alcohol portions, which are created by the reduction of naturally occurring triglycerides such as beef tallow, palm oil, peanut oil, turnip oil, cottonseed oil, soy oil, sunflower seed oil, and linseed oil or from their transesterification products with fatty acid esters occurring with the corresponding alcohols can be used according to the invention and thus represent a mixture of different fatty alcohols. Wool wax alcohols can also be used according to the invention.

Suitable liquid, hydrophobic oils have a melting point of less than 25° C. and a boiling point of preferably greater than 250° C., or particularly greater than 300° C. Volatile oils can also be used. In principle, any oil generally known to a person skilled in the art can be used. Suitable oils are vegetable or animal oils, mineral oils (liquid paraffin), silicone oils or their mixtures. Hydrocarbon oils, e.g., paraffin or isoparaffin oils, squalane, oils from fatty acids and polyols, especially triglycerides, are suitable. Suitable vegetable oils are, for example, sunflower oil, coconut oil, castor oil, lanolin oil, jojoba oil, corn oil, soy oil.

Suitable emulsifiers can include nonionic, anionic, cationic, or zwitterionic surfactants. Suitable non-ionic surfactants are, for example,
ethoxylated fatty alcohols, fatty acids, fatty acid glycerides, or alkyl phenols, especially addition products of 2 to 30 mol ethylene oxide and/or 1 to 5 mol propylene oxide to C8 to C22 fatty alcohols, to C12 to C22 fatty acids, or to alkyl phenols with 8 to 15 C atoms in the alkyl group;
C12 to C22 fatty acid mono- and diesters of addition products of 1 to 30 mol ethylene oxide to glycerol;
addition products of 5 to 60 mol ethylene oxide to castor oil or hydrogenated castor oil;
fatty acid sugar esters, especially esters from saccharose and one or two C8 to C22 fatty acids, INCI: Sucrose Cocoate, Sucrose Dilaurate, Sucrose Distearate, Sucrose Laurate, Sucrose Myristate, Sucrose Oleate, Sucrose Palmitate, Sucrose Ricinoleate, Sucrose Stearate;
esters from sorbitan and one, two or three C8 to C22 fatty acids and a degree of ethoxylation of 4 to 20;
polyglyceryl fatty acid esters, especially from one, two or more C8 to C22 fatty acids and polyglycerol with preferably 2 to 20 glyceryl units;
alkylglucosides, alkyloligoglucosides, and alkylpolyglucoside with C8 to C22 alkyl groups, e.g. decyl glucoside or lauryl glucoside.

Suitable anionic surfactants are, for example, salts and esters of carboxylic acids, alkyl ether sulfates and alkyl sulfates, fatty alcohol ether sulfates, sulfonic acids and their salts (e.g., sulfosuccinates or fatty acid isethienates), phosphoric acid esters and their salts, acylamino acids and their salts. A comprehensive description of these anionic surfactants is found in the publication “FIEDLER—Lexikon der Hilfsstoffe” [FIEDLER—Lexicon of Adjuvants], volume 1, fifth edition (2002), pages 97 to 102, to which expressed reference is made. Preferred surfactants are mono-, di-, and/or triesters of phosphoric acid with addition products of from 2 to 30 mol ethylene oxide to C8 to C22 fatty alcohols.

Suitable amphoteric surfactants are, for example, derivatives of aliphatic quaternary ammonium, phosphonium, and sulfonium compounds of the formula

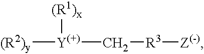

wherein R¹ represent a straight-chain or branched-chain alkyl, alkenyl, or hydroxyalkyl group with 8 to 18 C atoms and 0 to about 10 ethylene oxide units and 0 to 1 glycerol units; Y is an N—, P— or S—containing group; R² is an alkyl or monohydroxyalkyl group with 1 to 3 C atoms; the total of x+y equals 2 if Y is a sulfur atom, and the total of x+y equals 3 if Y is a nitrogen atom or a phosphorus atom; R³ is an alkylene or hydroxyalkylene group with 1 to 4 C atoms, and Z(-) represents a carboxylate, sulfate, phosphonate, or phosphate group. Other amphoteric surfactants such as betaines are also suitable. Examples of betaines include C8 to C18 alkylbetaines such as cocodimethylcarboxymethylbetaine, lauryldimethylcarboxymethylbetaine, lauryldimethyl-alpha-carboxyethylbetaine, cetyldimethylcarboxymethylbetaine, oleyldimethylgammacarboxypropylbetaine, and lauryl-bis-(2-hydroxypropyl)-alpha-carboxyethylbetaine; C8 to C18 sulfobetaines such as cocodimethylsulfopropylbetaine, stearyldimethylsulfopropylbetaine, lauryldimethylsulfoethylbetaine, lauryl-bis-(2-hydroxyethyl)sulfopropylbetaine; the carboxyl derivatives of imidazole, C8 to C 18 alkyldimethylammonium acetate, C8 to C18 alkyldimethylcarbonylmethylammonium salts, as well as C8 to C18 fatty acid alkylamidobetaines such as, for example, coconut fatty acid amidopropylbetaine and N-coconut fatty acid amidoethyl-N-[2-(carboxymethoxy)ethyl]-glycerin (CTFA name: cocoamphocarboxyglycinate).

Suitable cationic surfactants contain amino groups or quaternized hydrophilic ammonium groups that carry a positive charge in solution and can be represented by the general formula

N(+)R¹R²R³R⁴ X(-)

wherein R¹ to R⁴, independently from one another, stand for aliphatic groups, aromatic groups, alkoxy groups, polyoxyalkylene groups, alkylamido groups, hydroxyalkyl groups, aryl groups, or alkaryl groups with 1 to 22 C atoms, wherein at least one radical has at least 6, preferably at least 8, C atoms and X⁻ represents an anion, for example a halide, acetate, phosphate, nitrate, or alkyl sulfate, but preferably a chloride. In addition to the carbon atoms and the hydrogen atoms, the aliphatic groups can also contain cross-compounds, or other groups, such as, for example, additional amino groups. Examples of suitable cationic surfactants are the chlorides or bromides of alkyldimethylbenzylammonium salts, alkyltrimethylammonium salts, e.g., cetyltrimethylammonium chloride or bromide, tetradecyltrimethylammoniurn chloride or bromide, alkyldimethylhydroxyethylammonium chlorides or bromides, dialkyldimethylammonium chlorides or bromides, alkylpyridinium salts, for example lauryl- or cetylpyridinium chloride, alkylamidoethyltrimethylammonium ether sulfates as well as compounds with cationic character such as amine oxides, e.g., alkylmethylamine oxides or alkylaminoethyldimethylamine oxides. Especially preferred are C8-22 alkyldimethylbenzylammonium compounds, C8-22 alkyltrimethylammonium compounds, especially cetyltrimethylammonium chloride, C8-22 alkyldimethylhydroxyethylanmuonium compounds, di-(C8-22 alkyl)-dimethylammonium compounds, C8-22 alkylpyridinium salts, C8-22 alkylamidoethyltrimethylammonium ether sulfates, C8-22 alkylmethylamine oxides, and C8-22 alkylaminoethyldimethylamine oxides.

The cosmetic composition to be used according to the present invention can also contain at least one additional active cosmetic ingredient or additive for the hair or skin/scalp. This active ingredient or additive can, for example, be selected from hair-conditioning materials, hair-setting materials, silicone compounds, light-protection materials, preservatives, pigments, direct-penetrating hair dyes, particle-shaped materials, and oxidative hair colorant precursor products. The active ingredients and additives, depending on the type and intended use, are preferably contained in a quantity of from 0.01 to 20 wt %, or particularly of from 0.05 to 10, or of from 0.1 to 5 wt %.

In one embodiment, the agent according to the invention, as a hair-conditioning or hair-setting additive, contains at least one polymer with anionic groups or groups that can be anionized preferably in a quantity of from 0.01 to 20 wt %, or of from 0.05 to 10 wt %, with 0.1 to 5 wt % being particularly preferred. Groups that can be ionized are understood to mean acid groups such as, for example, carboxylic acid, sulfonic acid, or phosphoric acid groups, which can be deprotonated using typical bases such as, for example, organic amines or alkali or alkaline earth hydroxides. The anionic polymers can be partially or completely neutralized with an alkaline neutralizing agent. Such types of agents in which the acidic groups are neutralized in the polymer to 50 to 100%, or especially preferably to 70-100%, are preferred. Organic or inorganic bases can be used as the neutralizing agent. Particular examples of bases are amino alkanols such as, for example, aminomethylpropanol (AMP), triethanolamine or monoethanolamine, and also ammonia, NaOH, and KOH among others.

The anionic polymer can be a homo- or copolymer with acid group-containing monomer units derived from natural or synthetic sources, which, if necessary, can be polymerized with comonomers that contain no acid groups. Among the acid groups that can be considered are sulfonic acid, phosphoric acid, and carboxylic acid groups, of which the carboxylic acid groups are preferred. Suitable acid group-containing monomers are, for example, acrylic acid, methacrylic acid, crotonic acid, maleic acid, and maleic anhydride, maleic acid monoesters, especially the C1 to C7 alkyl monoesters of maleic acid, as well as aldehydocarboxylic acids or ketocarboxylic acids. Comonomers that are not substituted with acid groups are, for example, acrylamide, methacrylaminde, alkyl- and dialkylacrylamide, alkyl and dialkylmethacrylamide, alkyl acrylate, alkyl methacrylate, vinylcaprolactone, vinylpyrrolidone, vinyl ester, vinyl alcohol, propylene glycol or ethylene glycol, amine-substituted vinyl monomers such as, for example, dialkylaminoalkyl acrylate, dialkylaminoalkyl methacrylate, monoalkylaminoalkyl acrylate, and monoalkylaminoalkyl methacrylate, wherein the alkyl groups of these monomers are preferably C1 to C7 alkyl groups, with C 1 to C3 alkyl groups being especially preferred.

Suitable polymers with acid groups are especially homopolymers of acrylic acid or methacrylic acid, copolymers of acrylic acid or methacrylic acid with monomers selected from acrylic acid or methacrylic acid esters, acrylamides, methacrylamides and vinylpyrrolidone, homopolymers of crotonic acid as well as copolymers of crotonic acid with monomers selected from vinyl esters, acrylic acid or methacrylic acid esters, acrylamides and methacrylamides that are uncrosslinked or crosslinked with polyfinctional agents. A suitable natural polymer is, for example, shellac.

Preferred polymers with acid groups are: Terpolymers from acrylic acid, alkyl acrylate, and N-alkylacrylamide (INCI designation: Acrylate/Acrylamide Copolymer), especially terpolymers from acrylic acid, ethyl acrylate and N-tert-butylacrylamide; crosslinked or uncrosslinked vinyl acetate/crotonic acid copolymers (INCI designation: VA/Crotonate Copolymer); copolymers from one or more C1 to C5 alkyl acrylates, especially C2 to C4 alkyl acrylates and at least one monomer selected from acrylic acid or methacrylic acid (INCI designation: Acrylate Copolymer), e.g., terpolymers from tert-butyl acrylate, ethyl acrylate and methacrylic acid; sodium polystyrenesulfonate; vinylacetate/crotonic acid/vinyl alkanoate copolymers, for example, copolymers from vinyl acetate, crotonic acid and vinyl propionate; copolymers from vinyl acetate, crotonic acid and vinyl neodecanoate (INCI designations: VA/Crotonate/Vinyl Propionate Copolymer, VA/Crotonate/Vinyl Neodecanoate Copolymer); aminomethylpropanol acrylate copolymers; copolymers from vinylpyrrolidone and at least one further monomer selected from acrylic acid and methacrylic acid as well as, if necessary, acrylic acid esters and methacrylic acid esters; copolymers from methyl vinyl ether and maleic acid monoalkylesters (INCI designations: Ethyl Ester of PVM/MA Copolymer, Butyl Ester of PVM/MA Copolymer); aminomethylpropanol salts of copolymers from allyl methacrylate and at least one further monomer selected from acrylic acid, and methacrylic acid as well as, if necessary, acrylic acid esters and methacrylic acid esters; crosslinked copolymers from ethyl acrylate and methacrylic acid; copolymers from vinyl acetate, mono-n-butyl maleate and isobomyl acrylate; copolymers from two or more monomers selected from acrylic acid and methacrylic acid as well as, if necessary, acrylic acid esters and methacrylic acid esters; copolymers from octylacrylamide and at least one monomer selected from acrylic acid and methacrylic acid as well as, if necessary, acrylic acid esters and methacrylic acid esters; polyesters from diglycol, cyclohexanedimethanol, isophthalic acid and sulfoisophthalic acid, wherein the alkyl groups of the aforementioned polymers as a rule preferably possess 1, 2, 3, or 4 C atoms.

In one embodiment, the agent according to the invention, as a hair-conditioning or hair-setting additive, contains at least one zwitterionic and/or amphoteric polymer preferably in a quantity of from 0.01 to 20 wt %, or of from 0.05 to 10 wt %, or especially preferably of from 0.1 to 5 wt %. Zwitterionic polymers simultaneously have at least one anionic and at least one cationic charge. Amphoteric polymers exhibit at least one acidic group (e.g., carboxylic acid or sulfonic acid group) and at least one alkaline group (e.g., amino group). Acidic groups can be deprotonated using typical bases such as, for example, organic amines or alkali- or alkaline earth hydroxides.

Preferred zwitterionic or amphoteric polymers are: copolymers formed from alkylacrylamide, alkylaminoalkyl methacrylate, and two or more monomers from acrylic acid and methacrylic acid as well as, if necessary, their esters, especially copolymers from octylacrylamide, acrylic acid, butylaminoethyl methacrylate, methyl methacrylate and hydroxypropyl methacrylate (INCI designation: Octylacrylamide/Acrylate/Butylaminoethyl Methacrylate Copolymer); copolymers, that are formed from at least one of a first type of monomer that possesses quaternary amino groups and at least one of a second type of monomer that possesses acid groups; copolymers from fatty alcohol acrylates, alkylamine oxide methacrylate and at least one monomer selected from acrylic acid and methacrylic acid as well as if necessary acrylic acid esters and methacrylic acid esters, especially copolymers from lauryl acrylate, stearyl acrylate, ethylamine oxide methacrylate and at least one monomer selected from acrylic acid and methacrylic acid as well as if necessary their esters; copolymers from methacryloyl ethyl betaine and at least one monomer selected from methacrylic acid and methacrylic acid esters; copolymers from acrylic acid, methyl acrylate and methacrylamidopropyltrimethylammonium chloride (INCI designation: Polyquatemium-47); copolymers from acrylamidopropyltrimethylammonium chloride and acrylates or copolymers from acrylamide, acrylamidopropyltrimethylammonium chloride, 2-amidopropylacrylamide sulfonate, and dimethylaminopropylamine (INCI designation: Polyquatemium-43); oligomers or polymers, producible from quaternary crotonoylbetaines or quaternary crotonoylbetaine esters.

In one embodiment, the agent according to the present invention, as a hair-conditioning or hair-setting additive, contains at least one cationic polymer. The cationic polymers are contained in the composition to be used according to the present invention in a quantity that is preferably 0.01 to 20 wt % or 0.05 to 10 wt %, with 0.1 to 5 wt % being particularly preferred. The polymers can be synthetic or natural polymers. The polymers are hair-setting and/or hair-conditioning polymers that preferably form a film as well. Natural polymers are understood to also include chemically modified polymers of natural origin. Hair-setting polymers are understood to be those capable of exhibiting a setting effect on the hair or a stabilizing effect on the hairstyle when used in a 0.01 to 5% aqueous, alcoholic, or aqueous alcoholic solution or dispersion, e.g., those that increase curl retention with respect to a water wave, especially those for which the “Hair Fixatives” function is indicated in the International Cosmetic Ingredient Dictionary and Handbook, 10th edition, 2004. Hair-conditioning polymers are understood to be those capable of exhibiting a hair-conditioning or conditioning effect on the hair when used in a 0.01 to 5% aqueous, alcoholic, or aqueous alcoholic solution or dispersion, e.g., those that improve the combing ability or increase shine, especially those for which the “Hair Conditioning Agents” function is indicated in the International Cosmetic Ingredient Dictionary and Handbook, 10th edition, 2004. Film-forming polymers are understood to be those capable of depositing a polymer film on the hair after drying when used in a 0.01 to 5% aqueous, alcoholic, or aqueous alcoholic solution or dispersion, especially those for which the “Film Formers” function is indicated in the International Cosmetic Ingredient Dictionary and Handbook, 10th edition, 2004. The polymers can also simultaneously have two or three of the properties known as “film-forming, ” “hair-setting,” and “hair-conditioning.”Cationic polymers are polymers with cationic groups or with amine groups, particularly primary, secondary, tertiary, or quaternary amine groups. The cationic charge density will preferably be 1 to 7 meq/g.

Suitable synthetic cationic polymers are homo- or copolymers consisting of at least one of the following monomers: dialkylaminoalkyl acrylate, dialkylaminoalkyl methacrylate, monoalkylaminoalkyl acrylate, and monoalkyl aminoalkyl methacrylate, trialkyl methacryloxyalkyl ammonium, trialkyl acryloxyalkyl ammonium, dialkyl diallyl ammonium, and quaternary vinyl ammonium monomers with cyclic groups containing cationic nitrogens.

Suitable cationic polymers preferably contain quaternary amino groups. Cationic polymers can be homo- or copolymers, where the quaternary nitrogen groups are contained either in the polymer chain or preferably as substituents on one or more of the monomers. The monomers containing ammonium groups can be copolymerized with non-cationic monomers. Suitable cationic monomer are unsaturated compounds that can undergo radical polymerization, which bear at least one cationic group, especially ammonium-substituted vinyl monomers such as, for example, trialkylmethacryloxyalkylammonium, trialkylacryloxyalkylammonium, dialkyldiallylammonium and quaternary vinylammonium monomers with cyclic, cationic nitrogen-containing groups such as pyridinium, imidazolium or quaternary pyrrolidones, e.g. alkylvinylimidazolium, alkylvinylpyridinium, or alkylvinylpyrrolidone salts. The alkyl groups of these monomers are preferably lower alkyl groups such as, for example, C1 to C7 alkyl groups, and especially preferred are C₁ to C3 alkyl groups.

The monomers containing ammonium groups can be copolymerized with non-cationic monomers. Suitable comonomers are, for example, acrylamide, methacrylamide, alkyl- and dialkylacrylamide, alkyl- and dialkylmethacrylamide, alkyl acrylate, alkyl methacrylate, vinylcaprolactone, vinylcaprolactam, vinylpyrrolidone, vinyl esters, for example vinyl acetate, vinyl alcohol, propylene glycol or ethylene glycol, wherein the alkyl groups of these monomers are preferably C₁ to C7 alkyl groups, and especially preferred are C₁ to C3 alkyl groups.

Suitable polymers with quaternary amino groups are, for example, those described in the CTFA Cosmetic Ingredient Dictionary under the designations Polyquatemium such as methylvinylimidazolium chloride/vinylpyrrolidone copolymer (Polyquaternium-16) or quaternized vinylpyrrolidone/dimethylaminoethyl methacrylate copolymer (Polyquaternium-11) as well as quaternary silicone polymers or silicone oligomers such as, for example, silicone polymers with quaternary end groups (Quaternium-80).

Preferred cationic polymers of synthetic origin: Poly(dimethyldiallyl ammonium chloride) (INCI: Polyquaternium-6); copolymers from acrylamide and dimethyldiallyl ammonium chloride; quaternary ammonium polymers, formed by the reaction of diethylsulfate, and one copolymer from vinyl pyrrolidone and dimethylaminoethyl methacrylate, particularly vinyl pyrrolidone/dimethylaminoethyl methacrylate methosulfate copolymer (e.g., Gafquat® 755 N, Gafquat® 734); quaternary ammonium polymers from methylvinylimidazolium chloride and vinyl pyrrolidone (e.g., LUVIQUAT® HM 550); polyquaternium-35; methacryloyl ethyl trimethyl ammonium chloride homopolymer (INCI: Polyquaternium-37); polyquaternium-57; polymer from trimethyl ammonium ethyl methacrylate chloride; terpolymers from dimethyldiallyl ammonium chloride, sodium acrylate, and acrylamide (e.g., Merquat® Plus 3300); copolymers from vinyl pyrrolidone, dimethylaminopropyl methacrylamide, and methacryloylamino propyl lauryl dimethyl ammonium chloride; terpolymers from vinyl pyrrolidone, dimethylaminoethyl methacrylate, and vinyl caprolactam (e.g., Gaffix® VC 713); vinyl pyrrolidone/methacrylamide propyl trimethylammonium chloride copolymers (e.g., Gafquat®V HS 100); copolymers from vinyl pyrrolidone and dimethylaminoethyl methacrylate; copolymers from vinyl pyrrolidone, vinyl caprolactam, and dimethylaminopropylacrylamide; poly- or oligoesters formed from at least one first type of monomer, which is selected from hydroxy acid substituted with at least one quaternary ammonium group; and dimethylpolysiloxanes terminally substituted with quaternary ammonium groups.

Suitable cationic polymers that are derived from natural polymers are especially cationic derivatives of polysaccharides, for example, cationic derivatives of cellulose, starch or guar. Furthermore, chitosan and chitosan derivatives are also suitable. Cationic polysaccharides are, for example, represented by the general formula

G-O—B—N⁺R^{a}R^{b}RX⁻

### G is an anhydroglucose residue, for example, starch or cellulose anhydroglucose;

### B is a divalent linking group, for example alkylene, oxyalkylene, polyoxyalkylene or hydroxyalkylene;

### R^{a}, R^{b}, and R^{c}, independently from one another, are alkyl, aryl, alkylaryl, arylalkyl, alkoxyalkyl, or alkoxyaryl, any of which can have up to 18 C atoms, wherein the total number of C atoms in R^{a}, R^{b}, and R^{c} is preferably a maximum of 20;

X is a conventional counter-anion, for example, a halide, acetate, phosphate, nitrate, or alkyl sulfate, preferably a chloride. Cationic celluloses are, for example, those with the INCI names Polyquatemium-4, Polyquatemium-10, or Polyquatemium-24. A suitable cationic guar derivative has, for example, the INCI designation Guar Hydroxypropyltrimonium Chloride.

Especially preferred cationically-active substances are chitosan, chitosan salts and chitosan derivatives. Chitosans that can be used according to the invention can be fully or partially deacetylated chitins. By way of example, the molecular weight can be distributed over a broad range, from 20,000 to about 5 million g/mol, for example from 30,000 to 70,000 g/mol. However, the molecular weight will preferably lie above 100,000 g/mol, and especially preferred from 200,000 to 700,000 g/mol. The degree of deacetylation is preferably from 10 to 99%, and especially preferably from 60 to 99%. A preferred chitosan salt is chitosonium pyrrolidone carboxylate, e.g., Kytamer® PC with a molecular weight of from about 200,000 to 300,000 g/mol and a degree of deacetylation of from 70 to 85%. Chitosan derivatives that can be considered include quatemized, alkylated or hydroxyalkylated derivatives, e.g., hydroxyethyl, hydroxypropyl or hydroxybutyl chitosan. The chitosans or chitosan derivatives are preferably present in their neutralized or partially neutralized form. The degree of neutralization will be preferably at least 50%, especially preferably between 70 and 100%, as calculated on the basis of the number of free base groups. For the neutralization agent, in principle any cosmetically compatible inorganic or organic acids can be used such as, for example, formic acid, tartaric acid, malic acid, lactic acid, citric acid, pyrrolidone carboxylic acid, hydrochloric acid and others, of which pyrrolidone carboxylic acid is especially preferred.

Preferred cationic polymers derived from natural sources: cationic cellulose derivatives from hydroxyethyl cellulose and diallyldimethyl ammonium chloride; cationic cellulose deviates from hydroxyethyl cellulose and trimethylammonium-substituted epoxide; chitosan and its salts; hydroxyalkyl chitosans and their salts; alkylhydroxyalkyl chitosans and their salts; N-hydroxyalkylchitosan alkyl ethers.

In another preferred embodiment, the agent according to the present invention contains 0.01 to 15 wt %, or preferably 0.5 to 10 wt %, of at least one synthetic or natural nonionic film-forming polymer. Natural polymers are understood to also include chemically modified polymers of natural origin. Film-forming polymers are understood to be polymers that, when applied in a 0.01 to 5% aqueous, alcoholic, or aqueous-alcoholic solution, are capable of depositing a polymer film on the hair. Suitable synthetic nonionic polymers are homo- or copolymers consisting of at least one of the following monomers: vinyl lactams such as, for example, vinyl pyrrolidone or vinyl caprolactam; vinyl esters such as, for example, vinyl acetate; vinyl alcohol, vinyl formamide, acrylamides, methacrylamides, alkyl acrylamides, dialkyl acrylamides, alkyl methacrylamides, dialkylmethacrylamides, alkyl acrylates, alkyl methacrylates, alkyl maleimides such as, for example, ethylmaleimide or hydroxyethylmaleimide, and alkylene glycols such as, for example, propylene glycol or ethylene glycol, wherein the alkyl or alkylene groups of these monomers are preferably C1 to C7 alkyl groups, with C1 to C3 alkyl groups being particularly preferred.

Suitable homopolymers are, for example, those of vinylcaprolactam, vinylpyrrolidone or N-vinylformamide. Further suitable synthetic, nonionic polymers are, for example, polyacrylamides, polyethylene glycol/polypropylene glycol copolymers, copolymerides from vinylpyrrolidone and vinyl acetate, terpolymers from vinylpyrrolidone, vinyl acetate, and vinyl propionate, polyacrylamides; polyvinyl alcohols as well as polyethylene glycol/polypropylene glycol copolymers. Suitable natural film-forming polymers are, in particular, those based on saccharide, preferably glucans, e.g., cellulose and derivatives thereof. Suitable derivatives are, in particular, those with alkyl and/or hydroxyalkyl substituents, wherein the alkyl groups can have, for example, 1 to 20, or preferably 1 to 4 C atoms, e.g., hydroxyalkyl cellulose. Preferred nonionic polymers are: polyvinylpyrrolidone, polyvinylcaprolactam, vinylpyrrolidone/vinyl acetate copolymers, polyvinyl alcohol, isobutylene/ethylmaleimide/hydroxyethylmaleimide copolymer; copolymers from vinylpyrrolidone, vinyl acetate, and vinyl propionate.

In one embodiment, the agent according to the invention contains, as a hair-conditioning ingredient, at least one silicone compound preferably in a quantity of from 0.01 to 15 wt %, with 0.1 to 5 wt % being particularly preferred. The silicone compounds include volatile and nonvolatile silicones and silicones that are soluble and insoluble in the agent. One embodiment is high-molecular-weight silicone with a viscosity of 1,000 to 2,000,000 cSt at 25° C., or preferably 10,000 to 1,800,000 or 100,000 to 1,500,000. The silicone compounds include polyalkyl and polyaryl siloxanes, particularly with methyl, ethyl, propyl, phenyl, methylphenyl, and phenylmethyl groups. Polydimethyl siloxanes, polydiethyl siloxanes, and polymethylphenyl siloxanes are preferred. Also preferred are shine-providing, arylated silicones with a refractive index of at least 1.46 or at least 1.52. The silicone compounds include, in particular, the materials with the INCI designations Cyclomethicone, Dimethicone, Dimethiconol, Dimethicone Copolyol, Phenyl Trimethicone, Amodimethicone, Trimethylsilylamodimethicone, Stearyl Siloxysilicate, Polymethylsilsesquioxane, and Dimethicone Crosspolymer. Silicone resins and silicone elastomers are also suitable, wherein these are highly crosslinked siloxanes. Crosslinked silicones can be used simultaneously to provide consistency to the preferably creamy, solid, or highly viscous composition. Crosslinked silicones are, for example, those with the INCI designations Acrylates/Bis-Hydroxypropyl Dimethicone Crosspolymer, Butyl Dimethiconemethacrylate/Methyl Methacrylate Crosspolymer, C30-45 Alkyl Cetearyl Dimethicone Crosspolymer, C30-45 Alkyl Dimethicone/Polycyclohexene Oxide Crosspolymer, Cetearyl Dimethicone/Vinyl Dimethicone Crosspolymer, Dimethicone Crosspolymer, Dimethicone Crosspolymer-2, Dimethicone Crosspolymer-3, Dimethicone/Divinyldimethicone/ Silsesquioxane Crosspolymer, Dimethicone/PEG- 10/15 Crosspolymer, Dimethicone/PEG- 15 Crosspolymer, Dimethicone/PEG-10 Crosspolymer, Dimethicone/Phenyl Vinyl Dimethicone Crosspolymer, Dimethicone/Polyglycerin-3 Crosspolymer, Dimethicone/Titanate Crosspolymer, Dimethicone/Vinyl Dimethicone Crosspolymer, Dimethicone/Vinyltrimethylsiloxysilicate Crosspolymer, Dimethiconol/Methylsilanol/Silicate Crosspolymer, Diphenyl Dimethicone Crosspolymer, Diphenyl Dimethicone/Vinyl Diphenyl Dimethicone/Silsesquioxane Crosspolymer, Divinyldimethicone/Dimethicone Crosspolymer, Lauryl Dimethicone PEG-15 Crosspolymer, Lauryl Dimethicone /Polyglycerin-3 Crosspolymer, Methylsilanol/Silicate Crosspolymer, PEG-10 Dimethicone Crosspolymer, PEG-12 Dimethicone Crosspolymer, PEG-10 Dimethicone/Vinyl Dimethicone Crosspolymer, PEG-10/Lauryl Dimethicone Crosspolymer, PEG-15/Lauryl Dimethicone Crosspolymer, Silicone Quatemium-16/Glycidoxy Dimethicone Crosspolymer, Styrene/Acrylates/Dimethicone Acrylate Crosspolymer, Trifluoropropyl Dimethicone/PEG-10 Dimethicone Crosspolymer, Trifluoropropyl Dimethicone/Trifluoropropyl Divinyldimethicone Crosspolymer, Trifluoropropyl Dimethicone/Vinyl Trifluoropropyl Dimethicone/Silsesquioxane Crosspolymer, Trimethylsiloxysilicate/Dimethicone Crosspolymer, Trimethylsiloxysilicate/Dimethiconol Crosspolymer, Vinyl Dimethicone/Lauryl Dimethicone Crosspolymer, Vinyl Dimethicone/Methicone Silsesquioxane Crosspolymer, and Vinyldimethyl/ Trimethylsiloxysilicate Stearyl Dimethicone Crosspolymer.

Preferred silicones are: cyclic dimethyl siloxanes, linear polydimethyl siloxanes, block polymers from polydimethyl siloxane and polyethylene oxide and/or polypropylene oxide, polydimethyl siloxanes with terminal or lateral polyethylene oxide or polypropylenoxide residues, polydimethyl siloxanes with terminal hydroxyl groups, phenyl-substituted polydimethyl siloxanes, silicone emulsions, silicone elastomers, silicone waxes, silicone gums, amino-substituted silicones, silicones substituted with quaternary ammonia groups, and crosslinked silicones.

In one embodiment, the agent according to the invention contains a light-protection material preferably in a quantity of from 0.01 to 10 wt %, or of from 0.1 to 5 wt %, with 0.2 to 2 wt % being particularly preferred. The light-protection materials include, in particular, all the light-protection materials mentioned in EP 1 084 696. The following are preferred: 4-methoxy cinnamic acid-2-ethylhexyl ester, methyl methoxy cinnamate, 2-hydroxy-4-methoxy benzophenone-5-sulfonic acid, and polyethoxylated p-aminobenzoate.

In one embodiment, the agent according to the present invention contains 0.01 to 20, especially preferably 0.05 to 10, or very especially preferably 0.1 to 5 wt % of at least one hair-conditioning additive, selected from betaine; panthenol; panthenyl ethyl ether; sorbitol; protein hydrolysates; plant extracts; A-B block copolymers from alkyl acrylates and alkyl methacrylates; A-B block copolymers from alkyl methacrylates, and acrylonitrile; A-B-A block copolymers from lactide and ethylene oxide; A-B-A block copolymers from caprolacton and ethylene oxide; A-B-C block copolymers from alkylene or alkadiene compounds, styrene and alkyl methacrylates; A-B-C block copolymers from acrylic acid, styrene, and alkyl methacrylates; star-shaped block copolymers; hyper-branched polymers; dendrimers; intrinsically electrically conducting 3,4-polyethylene dioxythiophenes and intrinsically electrically conducting polyanilines.

In one embodiment, the agent according to the invention contains 0.01 to 5, or especially preferably 0.05 to 1 wt %, of at least one preservative. Suitable preservatives are those materials listed with the “Preservatives” function in the International Cosmetic Ingredient Dictionary and Handbook, 10th edition, e.g., phenoxyethanol, benzylparaben, butylparaben, ethylparaben, isobutylparaben, isopropylparaben, methylparaben, propylparaben, iodopropynyl butylcarbamate, methyldibromoglutaronitrile, and DMDM hydantoin.

The composition to be used according to the invention can further contain any additive components that are conventional for hair treatment agents, for example perfume oils; opacifying agents such as, for example, ethylene glycol distearate, styrene/PVP copolymers or polystyrenes; humectants; shine providers; product dyes; antioxidants; each preferably in quantities of from 0.01 to 10 wt %, wherein the total quantity preferably does not exceed 10 wt %.

The composition contains cosmetically acceptable solvents, preferably an aqueous, alcoholic, or aqueous alcoholic medium. The lower alcohols with 1 to 4 C atoms, such as ethanol and isopropanol, can be contained as alcohols, particularly those typically used for cosmetic purposes. As additional co-solvents, organic solvents or a mixture of solvents with a boiling point of less than 400° C. can be contained in a quantity of from 0.1 to 15 wt % or preferably of from 1 to 10 wt %. Unbranched or branched hydrocarbons such as pentane, hexane, isopentane, and cyclic hydrocarbons such as cyclopentane and cyclohexane are particularly suitable as additional co-solvents. These volatile hydrocarbons can also be used as propellants. Other, especially preferred water-soluble solvents are glycerol, ethylene glycol, propanetriol, and propylene glycol in a quantity of up to 30 wt %.

The object of the invention is also a two-phase product for permanent hair shaping. The two-phase product contains:

(A) a product release system of the invention, wherein the composition of the product release system contains at least one keratin-reducing material and is non-fluid or highly viscous, or in particular is gel-like or creamy; and

(B) an additional composition, which contains at least one keratin-reducing material and is fluid and of a lower viscosity than the composition of product release system (A).

The object of the invention is also a combination product for permanent hair shaping containing:

(A) a first composition, which contains at least one keratin-reducing material, and

(B) a second composition, which contains at least one oxidizing agent, wherein one or both compositions (A) and (B) are in the form of a product release system according to the invention.

The object of the invention is also a method for permanent hair shaping, with which the hair is treated with a hair-keratin-reducing shaping agent before and/or after it is styled into the desired shape, the hair, if necessary, is rinsed with water after an action period that is sufficient for the permanent shaping of the hair, the hair is then subjected to an oxidative post-treatment, re-rinsed with water, styled, and then dried, wherein a product release system according to the invention is used as a hair-keratin-reducing shaping agent, wherein the composition contained in the product release system contains at least one keratin-reducing material and/or wherein a product release system according to the invention is used for the oxidative post-treatment, wherein the composition contained in the product release system contains at least one oxidizing agent.

The products according to the invention are characterized, constrained by their special application with the special aerosol spray system to be used according to the invention, by an excellent, targeted applicability and excellent distribution capacity. The advantages with the application are illustrated by the comfortable application, the more economical dispensing, and the consistency that is perceived by the user as being more pleasant. An additional advantage of the products according to the present invention is that differing spray properties can be precisely adjusted by simply varying the propellant, the propellant composition, or the propellant pressure; these spray properties were not previously possible for the underlying active ingredient compositions. The spray properties include everything from a fine aerosol atomized spray and snow-like drops to flakes of spray and spray foam.

The following examples should serve to illustrate further the object of the present invention.

### EXAMPLES

In the following examples, the individual active ingredient compositions were filled, along with the individually indicated propellants, into a pressure-resistant aerosol can and equipped with a capillary spray system, as can be obtained, for example, under the trade name TRUSPRAY® from Boehringer Ingelheim microParts GmbH. Valve diameters and valve balls of different sizes can be used; however, the following sizes are preferred:

| | |
|---|---|
| Valve diameter | 0.5 mm |
| Valve ball | 0.35 mm |

### Example

### Permanent Wave Cream

Active ingredient composition:

| | | |
|---|---|---|
| 4.0 | g | Cetyl/stearyl alcohol (Lanette ® O, Cognis) |
| 1.0 | g | Ceteareth-25 |
| 0.7 | g | Polyquaternium-6 |
| 14-18 | g | Ammonium thioglycolate, 70% |
| 2.8 | g | Ammonia, 25% |
| 3.8 | g | Ammonium hydrogen carbonate |
| 0.75 | g | Cetyltrimethylammonium chloride |
| 0.4-0.7 | g | Scent |
| balance to 100 | g | Water, completely desalinated |

optional addition:

| | |
|---|---|
| 1-5 g | Cysteine |
| 1-4 g | 2-Mercaptopropionic acid (thiolactic acid) |

Viscosity: 1,000- 1,200 mPas (25° C.))

pH value: 8.6

Fill ratios in wt %:

| Example | Active ingredient solution | propane/butane 4.8 bar | DME |
|---|---|---|---|
| 1A | 50 | | 50 |
| 1B | 60 | | 40 |
| 1C | 50 | 50 | |
| 1D | 60 | 40 | |

The time-consuming application with the brush is no longer necessary. The product can also be of particular good use as a hair root cream for targeted shaping of the hair roots. The product is also particularly well suited for use in conjunction with an aqueous, non-viscous permanent wave lotion for optimum targeting of the structural differences between the hair roots and the hair tips during the permanent wave procedure.

### Example 2

### Emulsion Fixing Agent For Permanent Wave Cream

Active ingredient composition:

| | | |
|---|---|---|
| 5 | g | Cetyl/stearyl alcohol (Lanette ® O, Cognis) |
| 1.7 | g | Ceteareth-25 |
| 0.5-1.0 | g | Polyquaternium-35 |
| 6 | g | Hydrogen peroxide, 50% |
| 0.1-0.2 | g | p-Acetaminophenol |
| 0.1 | g | Disodium hydrogen phosphate |
| 0.1 | g | Etidronic acid, 60% in water |
| 0.4-0.7 | g | Scent |
| balance to 100 | g | Water, completely desalinated |

Viscosity: 400- 1,000 mPas (shear speed 12.9 s-l, 25° C.)

pH value: 2.2- 2.8

### Fill ratios in wt %:

| Example | Active ingredient solution | propane/butane 4.8 bar | DME |
|---|---|---|---|
| 2A | 50 | | 50 |
| 2B | 60 | | 40 |
| 2C | 50 | 50 | |
| 2D | 60 | 40 | |
| 2E | 70 | 30 | |
| 2F | 70 | | 30 |

### Example 3

### Hair Smoothing Cream

Active ingredient composition:

| | | |
|---|---|---|
| 10 | g | Cetyl/stearyl alcohol (Lanette ® O, Cognis) |
| 2 | g | Ceteareth-25 |
| 3 | g | Vaseline |
| 16-18 | g | Ammonium thioglycolate, 70% |
| 3 | g | Ammonia, 25% |
| 0.4-0.7 | g | Scent |
| balance to 100 | g | Water, completely desalinated |

Viscosity: 2,000- 3,000 mPas (25° C.)

pH value: 9.0

Fill ratios in wt %:

| Example | Active ingredient solution | propane/butane 4.8 bar | DME |
|---|---|---|---|
| 3A | 50 | | 50 |
| 3B | 60 | | 40 |
| 3C | 50 | 50 | |
| 3D | 60 | 40 | |
| 3E | 70 | 30 | |
| 3F | 70 | | 30 |

### Example 4

### Cream Fixing For Hair Smoothing Agent

Active ingredient composition:

| | | |
|---|---|---|
| 11 | g | Cetyl/stearyl alcohol (Lanette ® O, Cognis) |
| 2.2 | g | Ceteareth-25 |
| 3 | g | Vaseline |
| 6 | g | Hydrogen peroxide, 50% |
| 0.1-0.2 | g | Salicylic acid |
| 0.1 | g | Disodium hydrogen phosphate |
| 0.1 | g | Etidronic acid, 60% in water |
| 0.4-0.7 | g | Scent |
| balance to 100 | g | Water, completely desalinated |

Viscosity: 4,000-6,000 mPas (shear speed 12.9 sol, 25° C.)

pH value:2.0- 2.6

Fill ratios in wt %:

| Example | Active ingredient solution | propane/butane 4.8 bar | DME |
|---|---|---|---|
| 4A | 50 | | 50 |
| 4B | 60 | | 40 |
| 4C | 50 | 50 | |
| 4D | 60 | 40 | |
| 4E | 70 | 30 | |
| 4F | 70 | | 30 |

The creamy composition of Examples 1 through 4 mean that they are very user-friendly in their application, i.e., they can be sprayed directly and precisely on the parts of the hair to be treated or on the hair roots without requiring any awkward use of the brush.

### Example 5

### Permanent Wave Gel For Root Perm Touch Up

Active ingredient composition:

| | | |
|---|---|---|
| Ammonium thioglycolate (70% aqueous solution) | 18.2 | g |
| Ammonia (25% aqueous solution) | 2.20 | g |
| Ammonium hydrogen carbonate | 3.50 | g |
| Polydimethyldiallyl ammonium chloride | 0.2 | g |
| (INCI: Polyquaternium-6) | | |
| 1,3-Butanediol | 1.00 | g |
| 1,2-Propylene glycol | 1.50 | g |
| Dipropylene glycol monoethyl ether | 2.00 | g |
| Urea | 3.50 | g |
| Cremophor ® EL (INCI: PEG-35 Castor Oil) | 1.50 | g |
| Hydrogenated castor triglyceride polyglycol ether | 1.00 | g |
| (INCI: PEG-40 Hydrogenated Castor Oil) | | |
| Natrosol ® 250 HHX (INCI: Hydroxyethyl | 1.0 | g |
| Cellulose | | |
| Perfume oil | 0.5 | g |
| Water | balance to 100 | g |

pH 8.6; viscosity: 2,700 mPas)(Haake visc. VT 550, SV DIN, shear speed 12.9 s⁻¹, 25° C.)

Aerosol fill:

The active ingredient composition is filled with dimethylether in a weight ratio of active ingredient: propellant=50:50 and 60:40.

Treatment of the hair for a root perm touch up:

Spraying gel onto the rolled-up root hair using the product release system, rinsing after an action period (8-15 min), then fixing. Only the root perm is touched up.

Results: New wave and movement in the hair root area; gentle treatment of the middle hair sections and tips, because they are not re-permed. This results in the following: excellent hold and very good combing properties in the hair, convenience and safety for the user due to the drop stability of the wave agent gel, user-friendly application of the thickened permanent wave agent, and the labor-intensive application with the brush no longer needed.

### Example 6

### Two-Phase Permanent Wave To Even Out Large Structural Differences Of Hair

Active ingredient composition phase 1:

| | | |
|---|---|---|
| Ammonium thioglycolate (70% aqueous solution) | 12.5 | g |
| Ammonia (25% aqueous solution) | 0.8 | g |
| Ammonium hydrogen carbonate | 4.0 | g |
| Polydimethyldiallyl ammonium chloride | 0.8 | g |
| (INCI: Polyquaternium-6) | | |
| Antara ® 430 (INCI: Styrene/VP Copolymer) | 0.3 | g |
| 1,2-Propylene glycol | 1.5 | g |
| Urea | 2.0 | g |
| Coconut fatty alcohol, ethoxylated with 8 moles of | 1.0 | g |
| ethylene oxide (INCI: Coceth-8) | | |
| Hydrogenated castor triglyceride polyglycol ether | 1.0 | g) |
| (INCI: PEG-40 Hydrogenated Castor Oil) | | |
| Natrosol ® 250 HHX (INCI: Hydroxyethyl | 0.25 | g |
| Cellulose | | |
| Perfume oil | 0.5 | g |
| Water | balance to 100 | g |

pH 8.2

Active ingredient composition phase 2:

| | | |
|---|---|---|
| Ammonium thioglycolate (70% aqueous solution) | 18.2 | g |
| Ammonia (25% aqueous solution) | 2.20 | g |
| Ammonium hydrogen carbonate | 3.50 | g |
| Plydimethyldiallyl ammonium chloride | 0.2 | g |
| (INCI: Polyquaternium-6) | | |
| 1,3-Butanediol | 1.00 | g |
| 1,2-Propylene glycol | 1.50 | g |
| Dipropylene glycol monoethyl ether | 2.00 | g |
| Urea | 3.50 | g |
| Cremophor ® EL (INCI: PEG-35 Castor Oil) | 1.50 | g |
| Hydrogenated castor triglyceride polyglycol ether | 1.00 | g |
| (INCI: PEG-40 Hydrogenated castor oil) | | |
| Natrosol ® 250 HHX (INCI: Hydroxyethyl | 0.9 | g |
| Cellulose | | |
| Perfume oil | 0.5 | g |
| Water | balance to 100 | g |

pH 8.6; viscosity: 2,700 mPas (Haake viscometer VT 550, SV DIN, shear speed 12.9s⁻¹, 25° C.) Phase 1 is used as a low-viscosity lotion; phase 2 is filled together with propellant to be used in a product release system according to the invention.

Aerosol filling of phase 2:

The common propellants can be used; dimethylether is preferably used. The active ingredient composition is filled in a weight ratio of active ingredient: propellant=50:50 and 60:40.

The 2-phase use enables evening out of large structural differences in the hair from the hair roots up to the hair tips.

Hair treatment: Application of liquid phase 1 of the wave agent to the rolled-up hair, then spraying thickened phase 2 of the gel to the rolled-up hair roots using the product release system according to the invention, rinsing after an action period (6-15 min), then fixing.

Results: Even wave from the hair roots to the tips, gentle treatment of the hair tips, excellent hold and very good combing properties for the hair; user-friendly application of the thickened permanent wave, agent of phase 2, omission of the otherwise customary and labor-intensive application with the brush.

### Example 7

### Fixing Gel For Liquid And Thickened Permanent Wave Agent

Active ingredient composition:

| | | |
|---|---|---|
| Hydrogen peroxide (50% aqueous solution) | 5.0 | g |
| Methacryloyl ethyl trimethyl ammonium chloride | 0.7 | g |
| homopolymer (INCI: Polyquaternium-37) | | |
| Polysorbate 40 | 1.0 | g |
| Salicylic acid | 0.15 | g |
| Eethylene diamine tetraacetic acid (INCI: EDTA) | 0.1 | g |
| 1,2-Propylene glycol | 1.50 | g |
| Phosphoric acid, 85% aqueous solution | 0.1 | g |
| Perfume oil | 0.5 | g |
| Water | balance to 100 | g |

pH 3.5; viscosity: 750 mPa s (Haake viscometer VT 550, SV DIN, 25° C.)

Aerosol fill:

The common propellants can be used; dimethylether is preferably used. The active ingredient composition is filled in a weight ratio of active ingredient: propellant=50:50, 60:40, and 70: 30.

Hair treatment:

Spraying the fixing gel on the rolled-up hair roots with the product release system according to the invention after rinsing out the wave agent, rinsing out after an action period (5-12 min), reapplying the fixing agent to the hair (post-fixing) after unrolling, rinsing out after another action period of 2-5 min.

Advantages: User-friendly application of the thickened fixing agent. The labor-intensive application of the agent with the mixing bowl and brush is no longer necessary.

### Example 8

### Hair Smoothing Gel

Active ingredient composition:

| | | |
|---|---|---|
| Ammonium thioglycolate (70% aqueous solution) | 18.2 | g |
| Ammonia (25% aqueous solution) | 2.20 | g |
| Ammonium hydrogen carbonate | 3.50 | g |
| Polydimethyldiallyl ammonium chloride | 0.9 | g |
| (INCI: Polyquaternium-6) | | |
| 1,2-Propylene glycol | 2.50 | g |
| Glycerol | 3.00 | g |
| Cremophor ® EL (INCI: PEG-35 Castor Oil) | 1.50 | g |
| Hydrogenated castor triglyceride polyglycol ether | 1.00 | g |
| (INCI: PEG-40 Hydrogenated Castor Oil) | | |
| Natrosol ® 250 HHX (INCI: Hydroxyethyl | 1.5 | g |
| Cellulose | | |
| Perfume oil | 0.5 | g |
| Water | balance to 100 | g |

pH 9.0; viscosity: 5,100 mPas (Haake visc. VT 550, SV DIN, shear speed 12.9 s⁻¹, 25° C.)

Aerosol fill:

The common propellants can be used; dimethylether is preferably used. The active ingredient composition is filled in a weight ratio of active ingredient: propellant=50:50 and 60 40.

Hair treatment:

Spraying the gel on dry hair with the product release system according to the invention and smoothing the hair with a comb (the comb can also be a part of the applicator), rinsing out after an action period (10 to 30 min), then fixing (action period of the fixing agent is 5 to 12 min); then, if necessary, use of a hot smoothing iron.

Results: Smooth hair with excellent hold and very good combing properties; the product release system according to the invention enables the application of very viscous gel that does not drip off or run onto the scalp; the convenience and safety for the user is therefore significantly improved; user-friendly application of the thickened permanent wave agent; time-consuming application with the brush no longer necessary.

### Example 9

### Gel Fixing For Hair Smoothing Agent

Active ingredient composition:

| | | |
|---|---|---|
| Hydrogen peroxide (50% aqueous solution) | 5.0 | g |
| Ammonium acryloyl dimethyltaurate/VP copolymer | 1.8 | g |
| Polysorbate 40 | 1.0 | g |
| Salicylic acid | 0.15 | g |
| Ethylene diamine tetraacetic acid (INCI: EDTA) | 0.15 | g |
| Glycerol | 3.0 | g |
| 1,2-Propylene glycol | 3.0 | g |
| Phosphoric acid (85% aqueous solution) | 0.1 | g |
| Perfume oil | 0.5 | g |
| Water | balance to 100 | g |

pH 3.5; viscosity: 3,550 mPas (Haake viscometer VT 550, SV DIN, shear speed 12.9 s⁻¹, 25° C.)

Aerosol fill:

The common propellants can be used; dimethylether is preferably used. The active ingredient composition is filled in a weight ratio of active ingredient: propellant=50:50, 60:40,and70 :30.

Hair treatment:

Spraying the fixing gel on the smoothed hair with the assistance of the product release system according to the invention after the reduction-agent-containing smoothing agent is rinsed out, rinsing out the fixing gel after an action period (5-12 min), and subsequently, if necessary, use of a hot smoothing iron.

Advantages: The product release system according to the invention enables the application of very viscous oxidizing-agent-containing gel that does not drip off or run off onto the scalp. The convenience and safety for the user is therefore significantly improved. An additional advantage is the user-friendly use of the thickened fixing agent. The time-consuming application with the brush is no longer necessary.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is

1. A product release system for atomizing compositions comprising a pressure-resistant packaging, a spray head comprising a capillary, and a composition comprising a propellant, wherein the atomization occurs using said capillary and wherein said composition comprises at least one reactive agent, which is selected from the group consisting of hair-keratin-reducing compounds, oxidizing agents, and mixtures thereof.

2. A product release system according to claim 1, wherein said composition comprises at least one hair-keratin-reducing compound, which is selected from the group consisting of mercaptoacetic acid, cysteine, thiolactic acid, and salts thereof.

3. A product release system according to claim 1, wherein said hair-keratin-reducing compound is contained in a quantity of from 0.5 to 25 wt % of the composition.

4. A product release system according to claim 1, wherein said composition comprises a disulfide of a hair-keratin-reducing compound.

5. A product release system according to claim 1, wherein said composition further comprises at least one oxidizing agent in a quantity of from 0.1 to 25 wt % of the composition, and wherein said oxidizing agent is selected from the group consisting of hydrogen peroxide, bromates, persulfates, perborates, percarbonates, peroxides, iodates, and mixtures thereof.

6. A product release system according to claim 5, wherein said composition has a pH of between 6 and 9 in the presence of a bromate and a pH value of between 2 and 6 in the absence of a bromate.

7. The product release system according to claim 5, wherein said composition comprises at least one peroxide as said oxidizing agent and additionally comprises at least one peroxide stabilizer.

8. The product release system according to claim 7, comprising said peroxide stabilizer in a quantity of from 0.01 to 2 wt % of the composition and wherein said peroxide stabilizer is selected from the group consisting of dialkali hydrogen phosphates, p-acetamidophenol, oxyquinoline salts, salicylic acid, salts of salicylic acid, 1-hydroxyethane- 1,1-diphosphonic acid, tetrasodium- 1-hydroxyethane- 1,1-diphosphonate, tetrasodium iminodisuccinate, ethylenediamine tetrasodium acetate, N-(4-ethoxyphenyl)acetamide and mixtures thereof.

9. A product release system according to claim 1, wherein said capillary has a diameter of 0.1 to 1 mm and a length of 5 to 100 mm.

10. A product release system according to claim 1, wherein the spray rate is 0.01 to 5 g/s.

11. A product release system according to claim 1, wherein said propellant is selected from the group consisting of propane, butane, dimethyl ether, fluorinated hydrocarbons, and mixtures thereof.

12. A product release system according to claim 1, wherein said composition is non-fluid, gel-like, waxy, emulsion-like, creamy, pasty, or solid.

13. A product release system according to claim 5, wherein said composition comprises at least one thickener or at least one gel-former in a quantity of from 0.01 to 20 wt % of the propellant-free composition.

14. A product release system according to claim 13, wherein said thickener or said gel-former is a thickening polymer, selected from the group consisting of copolymers which are made from at least one first type of monomer and from at least one second type of monomer, wherein said first type of monomer is selected from the group consisting of acrylic acid and methacrylic acid and wherein said second type of monomer is an ethoxylated fatty alcohol acrylic acid ester, crosslinked polyacrylic acid, crosslinked copolymers which are made from at least one first type of monomer, and from at least one second type of monomer, wherein said first type of monomer is selected from the group consisting of acrylic acid and methacrylic acid and wherein said second type of monomer is a C10 to C30 alcohol acrylic acid ester, copolymers made from at least one first type of monomer and from at least one second type of monomer, wherein said first type of monomer is selected from the group consisting of acrylic acid and methacrylic acid and wherein said at least one second type of monomer is an ester of itaconic acid or an ethoxylated fatty alcohol, copolymers from at least one first type of monomer, from at least one second type of monomer and from at least one third type of monomer, wherein said first type of monemer is selected from the group consisting of acrylic acid and methacrylic acid and wherein said at least one second type of monomer is an ester of itaconic acid and ethoxylated C10 to C30 alcohol and wherein said third type of monomer is a C1 to C4 aminoalkyl acrylate, copolymers of two or more monomers selected from the group consisting of acrylic acid, methacrylic acid, acrylic acid esters, and methacrylic acid esters, copolymers of vinyl pyrrolidone and ammonium acryloyl dimethyltaurate, copolymers of ammonium acryloyl dimethyltaurate and at least one second monomer, wherein said second monomer is an ester of methacrylic acid and ethoxylated fatty alcohol, hydroxyethyl cellulose, hydroxypropyl cellulose, hydroxypropyl guar, glyceryl polyacrylate, glycerylpoly methacrylate, ccopolymers of at least one first type of monomer and styrene, wherein said first type of monomer is selected from the group consisting of C2 alkylene, C3 alkylene and C4 alkylene, polyurethanes, hydroxypropyl starch phosphate, polyacrylamide, copolymers of maleic acid anhydride and methyl vinyl ether, wherein said copolymers of maleic acid anhydride is crosslinked with decadiene, locust bean gum, guar gum, xanthan, dehydroxanthan, carrageenan, karaya gum, hydrolyzed corn starch, copolymers of polyethylene oxide, fatty alcohols, and saturated methylene diphenyl diisocyanate.

15. A product release system according claim 1, wherein said composition has a viscosity of at least 200 mPa s, measured at 25° C. and at a shear rate of 12.9 s⁻¹.

16. A product release system according to claim 1, wherein said composition is either a water-in-oil emulsion, or an oil-in-water emulsion, or a microemulsion, and wherein said composition comprises from 0.1 to 30 wt % of the propellant-free composition of at least one emulsifier, from 1 to 20 wt % of the propellant-free composition of at least one hydrophobic material, and water, wherein said hydrophobic material is selected from the group consisting of fatty alcohols, oils, and mixtures thereof.

17. A product release system according to claim 16, wherein said hydrophobic material is selected from the group consiting of silicone oils, mineral oils, isoparaffin oils, paraffin oils, squalane, plant oils, decanol, octanol, octene, dodecanol, dodecenol, decenol, octadienol, dodecadienol, decadienol, oleyl alcohol, eruca alcohol, ricinol alcohol, stearyl alcohol, isostearyl alcohol, cetyl alcohol, lauryl alcohol, myristyl alcohol, arachidyl alcohol, capryl alcohol, caprin alcohol, linoleyl alcohol, linolenyl alcohol, behenyl alcohol, guerbet alcohols, and mixtures thereof.

18. A product release system according to claim 16, wherein said emulsifier is selected from the group consisting of addition products of 2 to 30 mol ethylene oxide to C8 to C22 fatty alcohols, addition products of 1 to 5 mol propylene oxide to C8 to C22 fatty alcohols, addition products of 2 to 30 mol ethylene oxide and 1 to 5 mol propylene oxide to C8 to C22 fatty alcohols, addition products of 2 to 30 mol ethylene oxide to C12 to C22 fatty acids, addition products of 1 to 5 mol propylene oxide to C12 to C22 fatty acids, addition products of 2 to 30 mol ethylene oxide and 1 to 5 mol propylene oxide to C12 to C22 fatty acids, addition products of 2 to 30 mol ethylene oxide alkyl phenols with 8 to 15 C atoms in the alkyl group, addition products of 1 to 5 mol propylene oxide to alkyl phenols with 8 to 15 C atoms in the alkyl group, addition products of 2 to 30 mol ethylene oxide and 1 to 5 mol propylene oxide alkyl phenols with 8 to 15 C atoms in the alkyl group, C12 to C22 fatty acid monoesters of addition products of 1 to 30 mol ethylene oxide to glycerol, C12 to C22 fatty acid diesters of addition products of 1 to 30 mol ethylene oxide to glycerol, addition products of 5 to 60 mol ethylene oxide to castor oil, addition products of 5 to 60 mol ethylene oxide to hydrogenated castor oil, mono-, di-, or triesters of phosphoric acid with addition products of 2 to 30 mol ethylene oxide to C8 to C22 fatty alcohols, esters of saccharose with one or two C8 to C22 fatty acids, esters of sorbitan and one, two, or three C8 to C22 fatty acids and having a degree of ethoxylation of from 4 to 20, polyglyceryl fatty acid esters of one, two, or more C8 to C22 fatty acids with polyglycerol of 2 to 20 glyceryl units, alkylglycosides, C8-22 alkyldimethyl benzyl ammonium compounds, C8-22 alkyltrimethyl ammonium compounds, C8-22 alkyldimethyl hydroxyethyl ammonium compounds, di-(C8-22-alkyl)-dimethyl ammonium compounds, C8-22 alkylpyridinium salts, C8-22 alkylamido ethyl trimethyl ammonium ether sulfates, C8-22 alkylmethyl amine oxides, C8-22 alkyl amino ethyl dimethyl amine oxides, amidoamines, and quatemized amidoamines.

19. A product release system according to claim 1, wherein said composition comprises at least one cationic polymer.

20. A product release system according to claim 19, wherein said cationic polymer comprises cationic groups or groups that can be cationized, and wherein said cationic polymer is contained in said composition in an amount of from 0.01 to 5 wt % of the propellant-free composition, and wherein said cationic polymer is selected from the group consisting of cationic cellulose compounds made from hydroxyethyl cellulose and diallyldimethyl ammonium chloride, cationic cellulose compounds made from hydroxyethyl cellulose and epoxide substituted with trimethyl ammonium, poly(dimethyldiallyl ammonium chloride), copolymers of acrylamide and dimethyldiallyl ammonium chloride, quaternary ammonium polymers, formed by the reaction of diethylsulfate with a copolymer of vinyl pyrrolidone and dimethylaminoethyl methacrylate, quaternary ammonium polymers of methylvinylimidazolium chloride and vinyl pyrrolidone, polyquatemium-35, polymers of trimethyl ammonium ethyl methacrylate chloride, polyquaternium-57, dimethylpolysiloxanes terminally substituted with quaternary ammonium groups, copolymers of vinyl pyrrolidone, dimethylaminopropyl methacrylamide and methacryloylamino propyl lauryl dimethyl ammonium chloride, chitosan, chitosan salts, hydroxyalkyl chitosan, hydroxyalkyl chitosan salts, alkyl hydroxyalkyl chitosans, alkyl hydroxyalkyl chitosan salts, N-hydroxyalkyl chitosan alkyl ether, a copolymer of vinyl caprolactam, vinyl pyrrolidone, dimethylaminoethyl methacrylate, copolymers of vinyl pyrrolidone, copolymers of dimethylaminoethyl methacrylate, vinyl caprolactam, dimethylaminopropylacrylamide, polyesters, formed from at least one monomer, which is a hydroxy acid that is substituted with at least one quaternary ammonium group, oligoesters, formed from at least one monomer, which is a hydroxy acid that is substituted with at least one quaternary ammonium group, and methacryloyl ethyl trimethyl ammonium chloride homopolymer.

21. A product release system according to claim 1, wherein said composition comprises at least one additional active ingredient selected from the group consisting of hair-conditioning materials, hair-setting materials, silicone compounds, light-protection materials, preservatives, pigments, direct-penetrating hair dyes, particle-shaped materials, oxidative hair dye precursor products, and mixtures thereof.

22. A product release system according to claim 21, comprising said active ingredients in a quantity of from 0.01 to 20 wt %, of the propellant-free composition.

23. A two-phase product for permanent hair shaping comprising;
(A) a product release system according to claim 1, wherein the composition of the product release system comprises at least one keratin-reducing material and wherein the composition is non-fluid or highly viscous and
(B) an additional composition, which comprises at least one keratin-reducing material and is fluid and of a lower viscosity than the composition of product release system (A).

24. A combination product for permanent hair shaping comprising;
(A) a first composition, which comprises at least one keratin-reducing material, and
(B) a second composition, which comprises at least one oxidizing agent, wherein one or both compositions (A) and (B) are present in the form of a product release system according to claim 1.
